(19) United States
(12) Patent Application Publication
(10) Pub. No.: US 2009/0198876 A1
(43) Pub. Date: Aug. 6, 2009

(54) Programmable Command Sequencer

(76) Inventors: Jimmy Kwok Lap Lai, Vancouver (CA); Yun Shon Low, Richmond (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 12/062,003

(22) Filed: Apr. 3, 2008

Related U.S. Application Data
(60) Provisional application No. 61/024,940, filed on Jan. 31, 2008.

(51) Int. Cl. G06F 12/02

(52) U.S. Cl. 711/103; 711/E12.008

(57) ABSTRACT

An embedded subsystem IC which provides simple procedures for an external CPU IC to invoke one or more functions provided by modules of the subsystem is disclosed. The embedded subsystem comprises at least one module to perform at least one function, a first memory, and a sequence controller. Each module is controlled by values stored in local registers of the module. The first memory stores at least one predefined sequence of instructions. Each instruction sequence controls a module to perform a function. The sequence controller comprises a second memory to store a vector table and a state machine. In response to receiving a command the CPU, the sequence controller obtains a start address in the first memory of an instruction sequence corresponding with the command. The state machine programs one or more registers of a module that performs the function identified by the command according to the instruction sequence that begins with the start address.

### CROSS REFERENCE TO RELATED APPLICATION

This application claims the benefit under 35 U.S.C. 119(e) of U.S. Provisional Patent Application Ser. No. 61/024,940, filed on Jan. 31, 2008, the content of which is incorporated herein by reference.

### FIELD

The present invention relates generally to activating functions performed by an embedded subsystem IC, and more particularly to efficient programming of embedded subsystem registers by a central processing unit.

### BACKGROUND

Computer systems include a central processing unit (“CPU”), a memory, input/output ports, and one or more busses for conveying address, data, and control signals. In addition, computer systems commonly include one or more subsystems, such as hardware that performs special tasks or that interfaces with a particular type of peripheral device. Physically, computer systems are often made up of several integrated circuits (“IC”) or chips: the CPU, one or more memory chips, and one or more subsystem chips.

An embedded subsystem IC may perform a number of functions. In order to invoke one of the functions, the CPU generally needs to program registers in the subsystem IC. However, when the CPU is used to program registers in an embedded subsystem chip a number of technical problems arise.

Programming registers in an embedded subsystem can be complex. Programming registers may involve dozens of steps. In addition to the need to write to a large number of different registers, the programming process generally includes repeatedly polling the embedded subsystem to learn if an action has been completed and reading back data from the registers. Each function performed by the embedded subsystem is activated by a unique sequence of steps. Further, the embedded subsystem may be capable of performing several dozen different functions and the CPU needs to understand the sequence of steps required to activate each function. Moreover, certain functions are invoked many times when the computer system is active and, therefore, the CPU needs to repeatedly perform the same register programming steps.

Technical problems include the fact that register programming can consume a significant number of CPU and bus cycles. This activity increases power consumption and degrades system performance. System performance is degraded because it takes the CPU a relatively long time to perform certain register programming sequences, and when the CPU is busy performing register programming it can not attend to other tasks that may be required. In addition, the complexity of software running on the CPU tends to increase as the number of different register programming operations that the CPU must perform increases. As software increases in complexity, it requires more time to develop and debug, and because it is larger, it takes more space in memory to store.

Accordingly, there is a need for methods and apparatus for more efficient programming of embedded subsystem registers.

### SUMMARY

In a computer system that includes a CPU and an embedded subsystem embodying principles of the invention, the CPU requests that a function be performed by transmitting a single command to the embedded subsystem. The CPU may then resume other processing tasks. A programmable sequence controller in the embedded subsystem identifies a first instruction in a sequence of instructions pre-stored in a memory using the single command to identify a memory address for the first instruction, and programs one or more registers of a module within the embedded subsystem that performs the requested function.

One embodiment is directed to a method for invoking a function in a computer system that includes a CPU IC that requests functions, an embedded subsystem IC that includes a sequence controller and one or more modules each for performing at least one function, and a first bus for coupling the CPU and the embedded subsystem. The method comprises: (a) operating the CPU to request that a function be performed by transmitting a single command to the embedded subsystem on the first bus; and (b) operating the sequence controller: to identify a first instruction in a sequence of instructions pre-stored in a memory using the single command to obtain a memory address for the first instruction, and to program at least one module that performs the function according to the instruction sequence by accessing the one or more registers of the module on a second bus.

Another embodiment is directed to an embedded subsystem providing simple procedures for an external CPU to invoke one or more functions provided by modules of the subsystem. The embedded subsystem comprises at least one module to perform at least one function, a first memory, and a sequence controller. Each module is controlled and configured by one or more values stored in at least one local register of the module. The first memory stores at least one predefined sequence of instructions. Each instruction sequence controls at least one module to perform a function. The sequence controller comprises a second memory to store a vector table and a state machine. In response to receiving a command the CPU, the sequence controller obtains a start address in the first memory of an instruction sequence corresponding with the command. The state machine obtains the start address from the vector table. In addition, the state machine programs one or more registers of a module that performs the function identified by the command according to the instruction sequence that begins with the start address.

This summary is provided to generally describe what follows in the drawings and detailed description and is not intended to limit the scope of the invention. Objects, features, and advantages of the invention will be readily understood upon consideration of the following detailed description taken in conjunction with the accompanying drawings.

### BRIEF DESCRIPTION OF THE DRAWINGS

FIG. 1 is a block diagram of an exemplary computer system comprising a CPU, an embedded subsystem embodying principles of the invention, the embedded subsystem having a plurality of functional modules, each module including local registers, a sequence controller, and a command RAM.

FIG. 2 is a block diagram showing a subset of one of the local register blocks of FIG. 1.

FIG. 3 shows two flow diagrams illustrating one example of programming one of the functional modules of FIG. 1.

FIG. 4 is a block diagram showing the sequence controller and command RAM of FIG. 1 in greater detail, the sequence controller including a state machine.

FIG. 5 is a schematic diagram of the state machine of FIG. 4.

FIG. 6 is a diagram illustrating code/data word formats according to one embodiment.

In the drawings and description below, the same reference numbers are used in the drawings and the description generally to refer to the same or like parts, elements, or steps.

### DETAILED DESCRIPTION

A variety of technical problems arise when a CPU is used to program registers in functional modules of an embedded subsystem IC. Such register programming can consume a significant number of CPU and bus cycles, which in turn increases power consumption and degrades system performance. In addition, the complexity of software running on the CPU tends to increase when the CPU is used to perform register programming.

These problems are solved in a computer system that includes a CPU IC and an embedded subsystem IC embodying principles of the invention. The CPU requests that a function be performed by transmitting a single command to the embedded subsystem. The CPU may then resume other processing tasks. A programmable sequence controller in the embedded subsystem identifies a first instruction in a sequence of instructions pre-stored in a memory. The single command is used to identify a memory address for the first instruction. The sequence controller programs one or more registers of a module within the embedded subsystem that performs the requested function.

An embedded subsystem IC embodying principles of the invention provides a number of advantages. Specifically, a sequence controller according to the invention hides the complexity of register programming from the CPU. Further, use of such a sequence controller reduces bus traffic on a host bus, reducing power requirements. In addition, the sequence controller may perform register programming faster than the CPU because it is dedicated to the task (the CPU may need to wait before it can access a host bus or it may need to respond to an interrupt request). Moreover, the use of the sequence controller may result in less power consumption because it is a much smaller block of logic than a CPU. In other words, the functionality provided by the CPU is obtained with smaller much smaller logic than required for a CPU. If the CPU has no other work to do, it may be able to enter a low-power sleep mode while the sequence controller performs register programming. Furthermore, the sequence controller is flexible enough to be easily adapted to perform different register programming sequences. Thus, programming sequences may be changed in the field, and the sequence controller may be easily re-used with a wide variety of register-programmable functional modules.

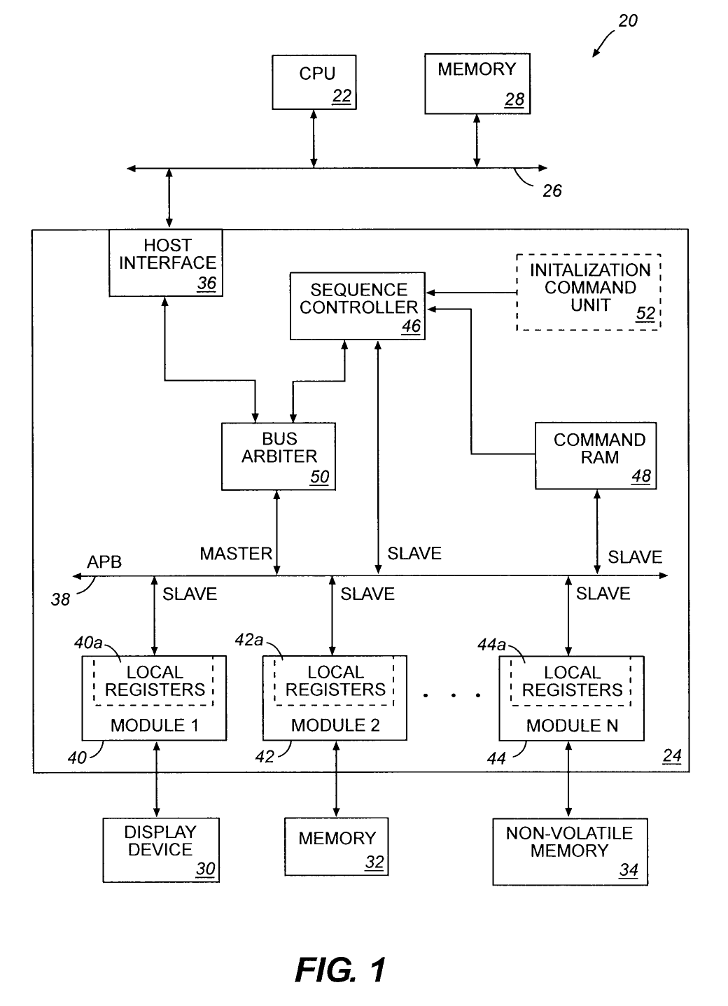

FIG. 1 is a block diagram of an exemplary computer system 20 comprising a CPU 22, an embedded subsystem 24, and a host bus 26 for coupling the CPU with a variety of subsystems and devices, such as a memory 28. In addition, the computer system 20 includes exemplary devices 30, 32 and 34 coupled with the embedded subsystem 24.

The CPU 22 may be disposed on a single IC, i.e., the CPU 22 may be a microprocessor. However, this is not critical. The CPU 22 may be disposed on more than one IC. In addition, the other components may be disposed on a single IC which includes the CPU 22. The CPU 22 may be a DSP, computer, or any other type of device for controlling a system. In one embodiment, the CPU 22 is a microprocessor based on the Advanced RISC Machine (“ARM”) architecture. The system 20 may include additional components not shown in FIG. 1. The memory 28 may be used by the CPU 22 or other components of the system 20. The host bus 26 may be, in one embodiment, an advanced high performance bus (AHB) or an Advanced System Bus (ASB), as defined in the Advanced Microcontroller Bus Architecture (AMBA) specification.

The embedded subsystem 24 may be disposed on a single IC, which is separate from the CPU. The embedded subsystem 24 may be separate for the CPU 22 because each is disposed on a separate IC. However, this is not critical. In one embodiment, the embedded subsystem 24 and the CPU 22 may be disposed on the same IC. In addition, where the embedded subsystem 24 is disposed on a single IC, it is not critical that every element shown in FIG. 1 as being included in the embedded subsystem 24 be disposed on this IC. For example, in one embodiment, the command RAM may be disposed off chip while other components are disposed on an embedded subsystem IC. As a second example, one of the functional modules further described below may located off chip.

The embedded subsystem 24 includes a host interface 36, an internal bus 38, and exemplary functional modules 40, 42, 44. In accordance with the principles of the present invention, the embedded subsystem 24 includes a sequence controller 46 and a command RAM 48. The exemplary embedded subsystem 24 may include a bus arbiter 50, depending on the properties of the internal bus 38. However, inclusion of the bus arbiter 50 is not critical. In addition, the exemplary embedded subsystem 24 optionally includes an initialization unit 52.

In one embodiment, the internal bus 38 is an advanced peripheral bus (APB) in accord with the AMBA specification. An APB only permits one bus master and the bus arbiter 50 is the designated bus master. The functional modules 40, 42, and 44 are coupled with internal bus 38 as bus slave devices. In addition, the command RAM 48 is coupled with internal bus 38 as bus slave device. The sequence controller 46 is coupled with the internal bus 38 as both a bus slave and a bus master (via the bus arbiter 50). Any device coupled with the internal bus 38 as a bus slave may have its local registers read or written to by any bus master. Similarly, any device coupled with the internal bus 38 as a bus master may read from or write to the local registers of any bus slave device. In one alternative, the internal bus 38 may be an AHB or ASB, which permit multiple bus masters, in which case the bus arbiter 50 need not be provided.

The embedded subsystem 24 includes at least one, but may include as many functional modules as desired. The functional modules may perform any of a wide variety of functions. A few examples of possible types of functional module include: a bus interface, an Inter-Integrated Circuit (I²C) bus controller, a timer, a power module, an SDRAM memory controller, a Flash memory controller, a phase-lock loop (“PLL”) unit, control logic, and a display controller. In the embedded subsystem 24, the exemplary module 40 is a display controller, the exemplary module 42 is a controller for a volatile memory such as an SDRAM, and the exemplary module 44 is a controller for a non-volatile memory, such as a flash memory.

Each functional module is controlled and configured by its local registers. The exemplary functional modules 40, 42, and 44 include local registers 40a, 42a, and 44a, respectively. The number of local registers included in a module, as well as the width (in bits) of the local registers may vary from module to module. Because the functional modules 40, 42, and 44 are slave devices on the internal bus 38, the bus master can read or write to any of the local registers.

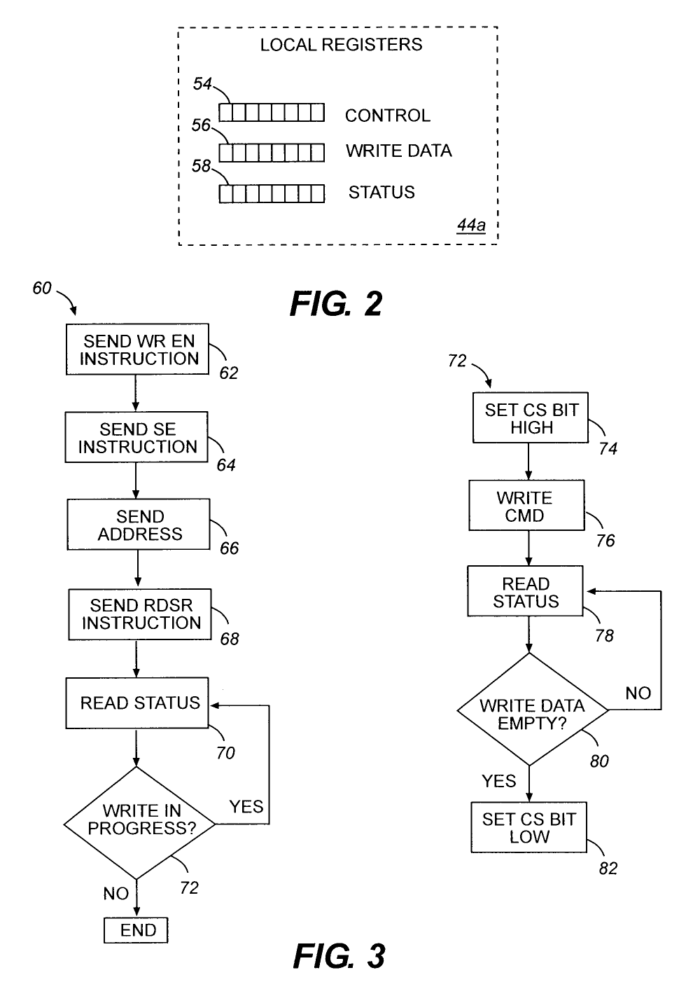

FIG. 2 is a block diagram showing a showing a subset of the local registers 44a of the functional module 44 in greater detail. The local registers 44a include a control register 54, a write data register 56, and a status register 58. The local registers 44a shown in FIG. 2 are a simplified representation, as a typical functional module includes a larger number of registers.

FIG. 3 shows two flow diagrams for explaining one example of register programming of a functional module. In this example, the module 44 may be a memory controller for a flash memory and one function the memory controller performs is to erase one sector of the flash memory. Referring first to the flow diagram 60, a write enable (WR EN) instruction is sent to the memory controller 44 to start a sector erase operation (step 62). A sector erase (SE) instruction is next sent to the memory controller 44 (step 64). The sector erase instruction is followed by the sending of three bytes of address (step 66). In other words, step 66 is repeated three times. In the next step 68, a read status register (RDSR) instruction is sent to the memory controller 44. Next the status register is read (step 70) and a check is made to determine if a “Write-in-Progress bit” is high. This last step is repeated until the Write-in-Progress bit is low.

Referring to the flow diagram 72, a process for writing one of the instructions referred to in flow diagram 60 to one of the registers in the module 44 is shown. In a first step 74, a chip select (CS) bit of the control register 54 is set high to select the flash memory device. In a second step 76, a command instruction, e.g., write enable, is written to the write data register 56. After the second step, the Write Data Empty flag is read from the status register (step 78). It is next determined if the “Write Data Empty flag” of the flash memory status register is high (step 80). The step 78 is repeated until the Write Data Empty flag is high. Once the command instruction stored in the write data register has been shifted out, the Write Data Empty Flag will be set high by the memory controller. The chip select (CS) bit of the control register is then set low (step 82). With the completion of this process one command instruction, e.g., write enable, has been programmed into the memory controller. This process is then repeated for the sector erase command, each of the three address bytes, and the read status command.

From this example, it is readily apparent that invoking a function to erase one sector of the flash memory involves a long series of steps with frequent polling of the functional unit to learn that the status of particular instructions. This example illustrates some of the complexities of register programming that it would be desirable to hide from an external CPU. In the prior art, however, the CPU 22 performs such register programming. However, having the CPU 22 perform register programming degrades system performance. It may take the CPU 22 a relatively long time to perform a register programming sequence such as, for example, when the CPU 22 is required to service an interrupt in the middle of the programming sequence. In addition, when the CPU 22 is busy performing register programming it can not attend to other tasks that it may be required to perform. Moreover, a large number of bus cycles on the host bus 26 and the internal bus 38 are required, which consumes power.

As stated above, a sequence controller embodying principles of the invention solves these problems. How an embedded subsystem that includes a sequence controller embodying principles of the invention solves these problems is explained below.

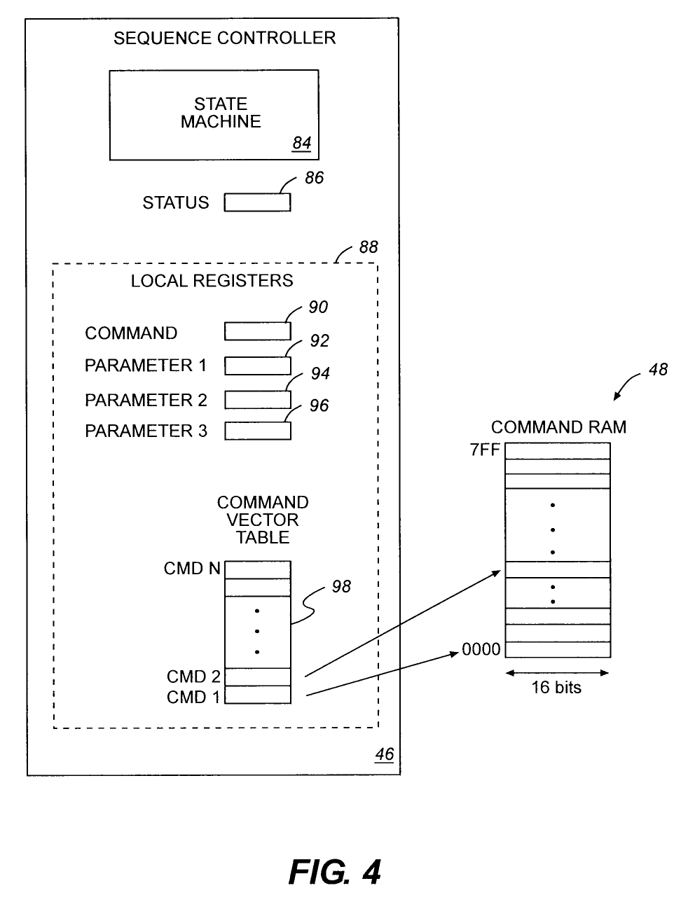

FIG. 4 is a block diagram illustrating the sequence controller 46 and command RAM 48 of FIG. 1 in greater detail. The sequence controller 46 includes a state machine 84, a status register 86, and local registers 88. The local registers 88 may include a command register 90, command parameter registers 92, 94, and 96, and a command vector table 98. While three command parameter registers are provided in one embodiment (and shown in FIG. 4), more or fewer registers may be provided in alternative embodiments. The command vector table 98 stores the starting addresses in the command RAM 48 for each set of instructions that the sequence controller 46 is capable of executing.

The command register 90 stores a current command to be executed. Each command includes at least a command code. Depending on the command code, a variety of command parameters may be required. The sequence controller 46, in one embodiment, accepts 37 commands from the CPU 22, as described in Table 1 below.

TABLE 1

| | | No. of | |
|---|---|---|---|
| | Command | Parameters | Description |
| 1 | INIT_CMD_SET | 3 | Initialize instruction code |
| | | | sequence from address in Serial |
| | | | Flash Memory |
| 2 | INIT_PLL_STBY | 3 | Initialize PLL and enter standby |
| | | | mode |
| 3 | RUN_SYS | 0 | Run system using PLL |
| 4 | STBY | 0 | Enter standby mode |
| 5 | SLP | 0 | Enter sleep mode |
| 6 | INIT_SYS_RUN | 0 | Initialize system and enter run state |
| 7 | INIT_SYS_STBY | 0 | Initialize system and enter standby state |
| 8 | INIT_SDRAM | 4 | Initialize SDRAM |
| 9 | INIT_DSPE_CFG | 5 | Initialize Display Controller |
| 10 | INIT_DSPE_TMG | 5 | Initialize driver timings |
| 11 | INIT_ROTMODE | 1 | Initialize rotation mode timings |
| 12 | RD_REG | 2 | Read register |
| 13 | WR_REG | 2 | Write register |
| 14 | RD_SFM | 0 | Trigger Serial Flash read operation |
| 15 | WR_SFM | 1 | Trigger Serial Flash write |
| | | | operation |
| 16 | END_SFM | 0 | End Serial Flash Memory |
| | | | operation |
| 17 | BST_RD_SDR | 4 | Start burst read SDRAM |
| 18 | BST_WR_SDR | 4 | Start burst write SDRAM |
| 19 | BST_END_SDR | 0 | End burst operation |
| 20 | LD_IMG | 1 | Load full image |
| 21 | LD_IMG_AREA | 5 | Load image area with parameters |
| 22 | LD_IMG_END | 0 | Load image end |
| 23 | LD_IMG_WAIT | 0 | Load image wait end |
| 24 | LD_IMG_SETADR | 2 | Set load image manual address |
| 25 | LD_IMG_DSPEADR | 0 | Set load image to use Display |
| | | | Controller's address |
| 26 | WAIT_DSPE_TRG | 0 | Wait for Display Controller trigger |
| | | | done |
| 27 | WAIT_DSPE_FREND | 0 | Wait for Display Controller frame |
| | | | end |
| 28 | WAIT_DSPE_LUTFREE | 0 | Wait for Display Controller at |
| | | | least 1 LUT is free |
| 29 | WAIT_DSPE_MLUTFREE | 1 | Wait for Display Controller at |
| | | | least 1 masked LUT is free |
| 30 | RD_WFM_INFO | 2 | Read waveform information |
| 31 | UPD_INIT | 0 | Update buffer initialize |
| 32 | UPD_FULL | 1 | Update buffer full |
| 33 | UPD_FULL_AREA | 5 | Update buffer full area |
| 34 | UPD_PART | 1 | Update buffer partial |
| 35 | UPD_PART_AREA | 5 | Update buffer partial area |
| 36 | UPD_GDVR_CLR | 0 | Gate driver clear command |
| 37 | UPD_SET_IMGADR | 2 | Set image buffer start address |

From Table 1, it can be seen that certain commands, such as the sleep command SLP, require no command parameters. Other commands may require several parameters. For example, the command to initialize display controller functional module 40 INIT_DSPE_CFG requires five parameters. As a second example, the LD_IMG_AREA also requires five parameters. The memory 32 may be used as a frame buffer and the LD_IMG_AREA command, in one embodiment, programs the memory controller functional unit 42. The LD_IMG_AREA command stores an area of pixel data into memory used as a frame buffer. The required parameters are for defining x and y coordinates of the area in a display frame, as well as for defining the width and height of the area.

One advantage of the use of the commands shown in Table 1 is that it is generally not required that the command code or command parameters specify which functional unit is to perform a function associated with the command. Nor is it generally necessary for the command code or the command parameters to specify the addresses of particular local registers that must by read from or written to. The addresses of the required registers are typically included in the command sequences, described below. Further, it is generally not necessary for the host to write all of the data and parameter information needed for a particular command sequence because some of this information may also be included in the command sequences.

One advantage of the use of the commands shown in Table 1 is that a single command may be used to program the local registers of more than one functional module. For example, the INIT_SYS_RUN command initializes a PLL functional module, an SDRAM functional module, e.g., module 42, a display controller functional module, e.g., module 40, a power control module, and a control module which places the chip in a “run” mode.

In operation, the CPU 22 stores any required command parameters in the command parameter registers 92-96, and then stores a command code in the command register 90. When the sequence controller 46 detects a write to the command register 90, it sets a “busy” bit in a status register 86. Logic in the sequence controller 46 matches the command code stored in the command register 90 with one of the commands stored in the command vector table 98 to obtain the starting address for the appropriate command sequence. The state machine 84 then starts fetching instructions from the command RAM 48 beginning at the specified address. Because the instruction sequences stored in the RAM 48 include instruction code words and data words, the term instruction may alternatively be referred to herein as a “code/data” word.

The state machine causes a first code/data word to be read from the Command RAM 48 beginning at the specified address. The instruction is decoded to determine the number of code/data words (1-4) needed to completely specify the current instruction. The state machine reads the proper number of code/data words and then reads information from or writes information to a specified local register in one of the modules, e.g., local registers 40a, or performs other action specified by the code/data words.

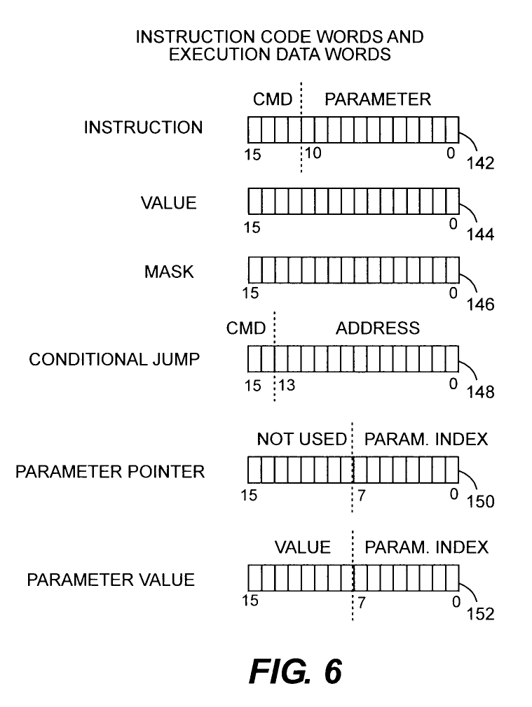

Code/data words may be 16 bits wide in one embodiment, and include instruction, value, mask, conditional, parameter pointer, and parameter value types. FIG. 6 illustrates code/data word formats according to one embodiment. All command sequences must start with a main instruction 142. The main instruction 142 includes an instruction code (bits [15:12]), a last instruction bit (bit [13]), and a register address (bits [10:0]). Depending on the instruction, the value, mask, conditional, parameter pointer, and parameter value data words may be additionally provided. The value data word 144 may be used to specify a value to write to a register or to specify a value to compare against data read back from a register. The mask data word 146 may be used for masking the data read back from a register before a comparison operation. In addition, the mask data word 146 may be used for masking a command parameter before writing the parameter to a register. The conditional data word 148 may be used for conditional branching. The conditional data word 148 includes a comparison code (bits [15:14]) and a jump address (bits [13:0]). The parameter pointer data word 150 may be used to identify which command parameter is to be used for the current instruction. The parameter pointer 150 includes a parameter index (bits [7:0]). The parameter value data word 152 is used with certain hybrid write parameter instructions (WPLLV, WPLHV, WPHLV, and WPHHV) described below. The parameter value data word 152 includes a value (bits [15:8]) and a parameter index (bits [7:0]).

In one embodiment, instruction codes are provided for 16 different types of instruction. Code/data words are fetched and processed according to logic which implements the state machine 84. The sixteen exemplary instruction codes are shown in Table 2 below.

TABLE 2

| | | No. of |
|---|---|---|
| Instruction | Description | data words |
| RCJ | Read, Compare, and Jump | 4 |
| RCWEQ | Read, Compare, and Wait until Equal | 3 |
| RCWNE | Read, Compare, and Wait until Not Equal | 3 |
| RRF | Read and Return Full | 1 |
| RRLL | Read and Return register Low byte to Low byte | 1 |
| RRLH | Read and Return register Low byte to High byte | 1 |
| WP | Write Parameter | 2 |
| WV | Write Value | 2 |
| WMPS | Write - Mux between Parameter and Stored | 3 |
| | Value | |
| WMVS | Write - Mux between Value and Stored Value | 3 |
| WMPV | Write - Mux between Parameter and Value | 4 |
| WPLLV | Write Parameter Low byte to Low byte, Value to | 2 |
| | high byte | |
| WPLHV | Write Parameter Low byte to High byte, Value to | 2 |
| | high byte | |
| WPHLV | Write Parameter High byte to Low byte, Value to | 2 |
| | high byte | |
| WPHHV | Write Parameter High byte to Low byte, Value to | 2 |
| | low byte | |
| JMP | Jump | 1 |

As can be seen from Table 2, the instruction codes are mainly for performing register reads and writes. While some instruction codes are known, others are optimized for performing register reads and writes. In particular, certain instructions perform in a single instruction the same operation that the CPU 22 would require two or more instructions to perform. In addition, other instructions are provided for easily accommodating different bus and register widths.

The “Read, Compare, and Wait until Equal” instruction performs a comparison operation using a single instruction. In contrast, the CPU 22 would require two or more instructions to perform these operations. The RCWEQ instruction uses three command/data words: a main instruction 142, a value data word 144, and a mask data word 146. The RCWEQ instruction ANDS the value in the specified register with a mask value. The result is compared with the value specified in the value data word 144. The instruction is repeated until the result of the comparison is equal. When equal, the state machine 84 proceeds to the next instruction.

Like the RCWEQ instruction, the “Read, Compare, and Wait until Not Equal” instruction is also a novel instruction that performs with a single instruction that which the CPU 22 would require two or more instructions to perform. The RCWNE instruction uses three command/data words: a main instruction 142, a value data word 144, and a mask data word 146. The RCWEQ instruction ANDS the value in the specified register with a mask value. The result is compared with the value specified in the value data word 144. The instruction is repeated until the result of the comparison is not equal. When not equal, the state machine 84 proceeds to the next instruction.

When the last instruction in the command sequence has been completed, the sequence controller 46 clears the busy bit in the status register 86. The CPU 22 may periodically poll the status register 86 to learn when the command sequence is finished. For example, the CPU 22 may check the status register 86 before sending a subsequent command. Optionally, the sequence controller 46 may send the CPU 22 an interrupt when the command sequence is finished.

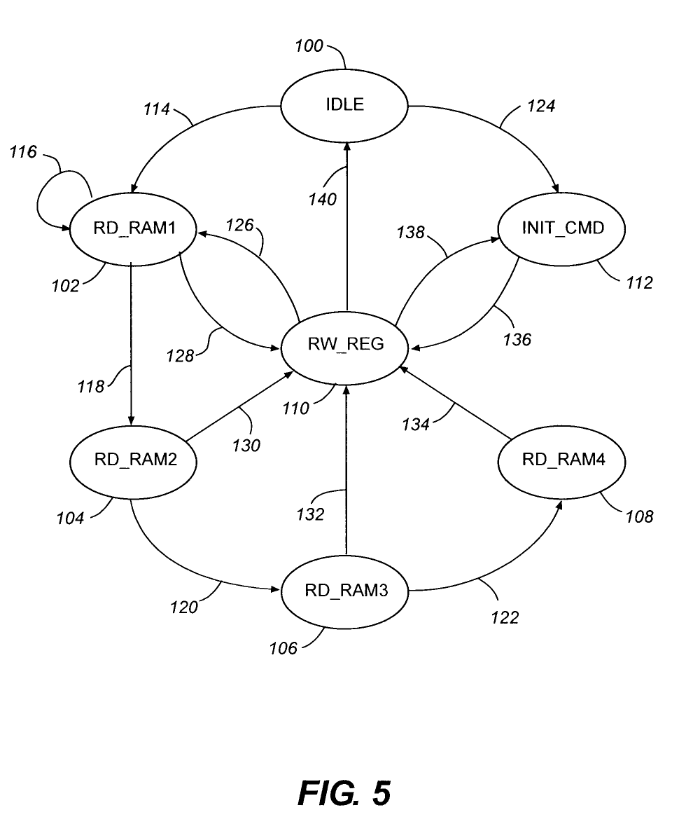

FIG. 5 is a schematic diagram of the state machine of FIG. 4. The state machine has seven states as shown in FIG. 5 and described in Table 3 below.

TABLE 3

| No. | State | Description |
|---|---|---|
| 100 | IDLE | Waiting for the next command |
| | | sequence to start. |
| 102 | RD_RAM1 | Reading the first word from command |
| | | RAM for the current instruction. |
| | | Instruction code will be decoded after |
| | | the reading and it will be determined |
| | | if more words have to be read for this |
| | | instruction. |
| 104 | RD_RAM2 | Reading the second word from |
| | | command RAM for the current |
| | | instruction. |
| 106 | RD_RAM3 | Reading the third word from |
| | | command RAM for the current |
| | | instruction. |
| 108 | RD_RAM4 | Reading the fourth word from |
| | | command RAM for the current |
| | | instruction. |
| 110 | RW_REG | Carry out the register read/write for |
| | | the current instruction. |
| 112 | INIT_CMD | Latching in the next register |
| | | read/write instruction from INIT |
| | | Command block |

Note that states 102-110 are only for commands other than an INIT_CMD. In addition, state 112 is only for the INIT_CMD.

The state machine 84, in one embodiment, has 14 transitions as described in Table 4 below.

TABLE 4

| Transition | Description |
|---|---|
| 114 | Received new command which is not INIT_CMD. |
| 116 | Read first word and instruction equals JMP. |
| 118 | Not read enough words and instruction not equal to JMP. |
| 120 | Not read enough words. |
| 122 | Not read enough words. |
| 124 | Power up or received INIT_CMD. |
| 126 | Register read/write done and (instruction <> |
| | RCJ/RCWEQ/RCWNE or compare condition met) and not |
| | last instruction. |
| 128 | Read enough words and instruction <> JMP. |
| 130 | Read enough words. |
| 132 | Read enough words. |
| 134 | Read enough words. |
| 136 | Always. |
| 138 | Register read/write done and command equals INIT_CMD. |
| 140 | Register read/write done and (instruction <> |
| | RCJ/RCWEQ/RCWNE or compare condition met) and last |
| | instruction. |

In one embodiment, when the computer system 20 is powered up, the CPU 22 stores the command sequences in the command RAM 48 and initializes the vector table 98. In one alternative, the optional initialization command unit 52 fetches the command sequences and vector table entries from a non-volatile memory, such as the non-volatile memory 34. The optional initialization command unit 52 stores the fetched information in the command RAM 48 and vector table 98. The initialization command unit 52 holds hard-wired codes for the initialization command sequence.

In one embodiment, the sequence controller 46 may perform some or all of the operations and methods described in this description by executing instructions that are stored in or on machine-readable media.

As shown in FIG. 1, the functional modules 40, 42, and 44 are disposed within the embedded system 24. In one embodiment, the embedded system 24 may be disposed on an IC and one or more the functional modules may be disposed off of a subsystem IC. In other words, in one embodiment, the embedded subsystem may include one or more off-chip functional modules.

In this description, references may be made to “one embodiment” or “an embodiment.” These references mean that a particular feature, structure, or characteristic described in connection with the embodiment is included in at least one embodiment of the claimed inventions. Thus, the phrases “in one embodiment” or “an embodiment” in various places are not necessarily all referring to the same embodiment. Furthermore, particular features, structures, or characteristics may be combined in one or more embodiments.

Although embodiments have been described in some detail for purposes of clarity of understanding, it will be apparent that certain changes and modifications may be practiced within the scope of the appended claims. Accordingly, the described embodiments are to be considered as illustrative and not restrictive, and the claimed inventions are not to be limited to the details given herein, but may be modified within the scope and equivalents of the appended claims. Further, the terms and expressions which have been employed in the foregoing specification are used as terms of description and not of limitation, and there is no intention in the use of such terms and expressions to exclude equivalents of the features shown and described or portions thereof, it being recognized that the scope of the inventions are defined and limited only by the claims which follow.

1. A method for invoking a function in a computer system that includes a CPU that requests functions, an embedded subsystem that includes a sequence controller and one or more modules, each module for performing at least one function, and a first bus for coupling the CPU and the embedded subsystem, comprising:
(a) operating the CPU to request that a function be performed by transmitting a single command to the embedded subsystem on the first bus; and
(b) operating the sequence controller:
to identify a first instruction in a sequence of instructions pre-stored in a memory using the single command to obtain a memory address for the first instruction, and
to program at least one of the modules that performs the function according to the sequence of instructions by accessing one or more registers of the one module on a second bus.

2. The method of claim 1, wherein transmitting the single command includes transmitting a command code to the embedded subsystem.

3. The method of claim 2, wherein transmitting the single command includes transmitting at least one command parameter to the embedded subsystem.

4. The method of claim 1, wherein programming the one module includes accessing at least one register of the one module.

5. The method of claim 1, further comprising storing in the memory at least one sequence of instructions by the CPU.

6. The method of claim 1, further comprising storing in the memory at least one sequence of instructions from a non-volatile memory.

7. The method of claim 1, wherein the sequence controller programs at least two of the one or more modules, each of the at least two modules performing a distinct function, in response to a single command for the CPU.

8. The method of claim 1, wherein the sequence of instructions includes an instruction to read a first value from one of the registers of the one module, to compare the first value with a second value to determine if the first value is equal to the second value, and to repeat the steps of reading the first value and comparing the first value with the second value until the determination is true.

9. The method of claim 1, wherein the sequence of instructions includes an instruction to read a first value from one of the registers of the one module, to compare the first value with a second value to determine if the first value is not equal to the second value, and to repeat the steps of reading the first value and comparing the first value with the second value until the determination is true.

10. The method of claim 1, wherein the CPU is disposed on an IC separate from the embedded subsystem.

11. The method of claim 1, wherein the embedded subsystem is disposed on an IC separate from the CPU.

12. An embedded subsystem providing procedures for an external CPU to invoke one or more functions provided by modules of the embedded subsystem, comprising:
at least one module to perform at least one function, the at least one module being controlled and configured by one or more values stored in at least one local register of the at least one module;
a first memory to store at least one predefined sequence of instructions, each instruction sequence to control the at least one module to perform a function;
a sequence controller comprising:
a second memory to store a vector table; and
a state machine to obtain a start address in the first memory of the sequence of instructions in response to receiving a command from the CPU, wherein the start address is obtained from a location in the vector table corresponding with the command, and to program the at least one local registers of the at least one module that performs the function identified by the command according to the sequence of instructions that begins with the start address.

13. The subsystem of claim 12, wherein the command comprises a command code.

14. The subsystem of claim 13, wherein the command comprises a command code and at least one command parameter.

15. The subsystem of claim 12, further comprising a first bus, wherein the command is transmitted from the CPU to the embedded system on the first bus.

16. The subsystem of claim 15, further comprising a second bus, wherein the sequence controller programs the at least one local registers of the at least one module by accessing the at least one local registers on the second bus.

17. The subsystem of claim 12, further comprising an initialization unit to store a sequence of instructions for reading from a third memory and storing in the first memory the at least one predefined sequence of instructions.

18. The subsystem of claim 12, wherein the sequence controller programs at least two modules, each of the at least two modules performing a distinct function, in response to a single command for the CPU.

19. The subsystem of claim 12, wherein the sequence of instructions includes an instruction to read a first value from the at least one local registers of the at least one module, to compare the first value with a second value to determine if the first value is equal to the second value, and to repeat the steps of reading the first value and comparing the first value with the second value until the determination is true.

20. The subsystem of claim 12, wherein the sequence of instructions includes an instruction to read a first value from the at least one local registers of the at least one module, to compare the first value with a second -value to determine if the first value is not equal to the second value, and to repeat the steps of reading the first value and comparing the first value with the second value until the determination is true.

21. The method of claim 12, wherein the CPU is disposed on an IC separate from the embedded subsystem.

22. The method of claim 12, wherein the embedded subsystem is disposed on an IC separate from the CPU.
